(19) United States
(12) Patent Application Publication
(10) Pub. No.: US 2015/0113426 A1
(43) Pub. Date: Apr. 23, 2015

(54) CRISIS INFORMATION DELIVERY DEVICE, CRISIS INFORMATION DELIVERY SYSTEM, METHOD, AND PROGRAM

(71) Applicant: NEC Corporation, Minato-ku, Tokyo (JP)

(72) Inventor: Ryosuke Okubo, Tokyo (JP)

(21) Appl. No.: 14/402,771

(22) PCT Filed: Jun. 17, 2013
(86) PCT No.: PCT/JP2013/003761

§ 371 Date: Nov. 21, 2014

(30) Foreign Application Priority Data
Jul. 10, 2012 (JP) 2012-154626

(51) Int. Cl. G06F 3/0481; H04L 29/08

(52) U.S. Cl. CPC G06F 3/0481; H04L 67/18
USPC 715/744

(57) ABSTRACT

To cause a person involved to intuitively understand how much a crisis influences himself/herself when the crisis beaks out, and to promote to take proper actions. A crisis information delivery device includes a diagram generation means for generating a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region.

### TECHNICAL FIELD

The present invention relates to a crisis information delivery device for delivering crisis information to a user, a crisis information delivery system, a user terminal, a crisis information delivery method, and a crisis information delivery program.

### BACKGROUND ART

Alarms calling for attentions or evacuation are widely spread via emergency municipal radio communication, TV, radio, Internet and cell phones when a crisis breaks out due to disasters such as earthquake, tsunami and floods, fire, accident, and the like. The alarm needs to be accurately, rapidly and easily delivered to all the persons who may be endangered, and needs to cause them to properly evacuate. However, since an accident may actually break out in a very short time or a person in the crisis may not keep calm, even if crisis information is given by an alarm, it cannot be correctly grasped soon in many cases. An endangered person “does not make the crisis his/her own” or “determines that he/she is safe on his/her own”, and thus may not evacuate and may consequently suffer damages in many cases.

There are proposed various techniques for delivering a crisis to persons involved accurately and in detail against the above problem. For example, an emergency information delivery system described in Patent Literature 1 creates URL contents in which a map image is added with disaster areas or evacuation spots depending on alarm contents delivered from an alerting service such as Meteorological Agency, and transmits the address thereof to cell phones with GPS function or users' computers. Further, it transmits the URL contents to the cell phones with GPS function or users' computers in response to users' requests. In this way, the system described in Patent Literature 1 delivers, to the users, map-form emergency information in which impacts on the region by the alarm are easily displayed and evacuation spots are also indicated.

For example, an emergency evacuation information system described in Patent Literature 2 originates disaster information as visible information from a monitor in addition to an audio alarm, and blinks a flash light thereby to call for attentions to the visible information on the monitor. The system described in Patent Literature 2 delivers emergency information in consideration of the deaf and hard of hearing and the healthy who are hard of hearing due to noises.

### CITATION LIST

### Patent Literature

PLT 1: JP 2006-235842 A

PLT 2: JP 2002-109670 A

### SUMMARY OF INVENTION

### Technical Problem

Some supports are present for delivering a crisis as an alarm accurately and in detail, but an accident may actually break out in a very short time or a person who may be endangered (which will be simply person involved below) may not keep calm. There is a problem that the crisis is not delivered to the person involved in a manner such that he/she can intuitively recognize it, and he/she cannot take an initial action such as evacuation after the delivery.

For example, with the emergency information delivery system described in Patent Literature 1, a user can browse the URL contents in which a map image is added with disaster areas and evacuation spots based on the notified address. However, the user has to request the URL contents, and additionally the user understand impacts on himself/herself with difficulty based on the alerting information in which the map image is added with disaster areas and evacuation spots. Generally, the map image is originally added with many items of information such as roads and buildings. Even if the alerting information added with disaster areas and evacuation spots is delivered, when an accident may actually break out in a very short time or a person cannot keep calm, it is difficult for the person involved to read his/her position, a disaster position and its magnitude, and evacuation spots, and to rapidly grasp how much he/she is in relation with the disaster and where he/she should escape.

For example, with the emergency evacuation information system described in Patent Literature 2, disaster information is displayed as visible information with the blinking flash light, and thus the deaf and hard of hearing and the healthy who are hard of hearing due to noises can know the outbreak of the disaster. However, the technique described in Patent Literature 2 only emphasizes that the outbreak of a disaster is accurately notified to the person involved, and does not particularly consider the contents to be notified. Thus, even if a crisis such as fire can be notified, when an alarm is issued, it is not possible to rapidly notify the person involved who may confront the crisis of how much he/she is in relation with the crisis or where he/she should escape.

It is an object of the present invention to provide a crisis information delivery device capable of enabling the person involved to intuitively understand how much a crisis influences himself/herself when the crisis break out and promoting to take proper actions, a crisis information delivery system, a user terminal, a crisis information delivery method, and a crisis information delivery program.

### Solution to Problem

A crisis information delivery device according to the present invention is characterized by including a diagram generation means for generating a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region.

A crisis information delivery system according to the present invention is characterized by including a user terminal, and a crisis information delivery server connected to the user terminal via a network, wherein the crisis information delivery server includes a diagram generation means for generating a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region, and a diagram transmission means for transmitting a diagram generated by the diagram generation means to the user terminal, and the user terminal includes a diagram reception means for receiving the diagram from the diagram transmission means, and a diagram display means for displaying the diagram received by the diagram reception means.

A user terminal according to the present invention is characterized by including a diagram display means for displaying a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region.

A crisis information delivery method according to the present invention is characterized by including the steps of generating a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region, and displaying the generated diagram on a user terminal.

A crisis information delivery program according to the present invention is characterized by causing a computer to perform a processing of generating a diagram in which a crisis, a user, and relevant objects for the user are arranged in a predetermined drawing region while the directions from the user at actual positions are kept, and crisis impacts as the degrees of hazard at the actual positions of the user and the relevant objects for the user are indicated in the distances from the crisis in the drawing region, and a processing of outputting the generated diagram.

A crisis information delivery program according to the present invention is characterized by causing a computer to perform a processing of displaying a diagram in which a crisis, a user, and relevant objects for the user are arranged in a predetermined drawing region while the directions from the user at actual positions are kept, and crisis impacts as the degrees of hazard at the actual positions of the user and the relevant objects for the user are indicated in the distances from the crisis in the drawing region.

### Advantageous Effects of Invention

According to the present invention, it is possible to deliver crisis information capable of enabling the person involved to intuitively understand how much a crisis influences himself/herself when the crisis breaks out and promoting to take proper actions.

### BRIEF DESCRIPTION OF DRAWINGS

FIG. 1 It depicts a block diagram illustrating an exemplary structure of a crisis information delivery device according to a first exemplary embodiment.

FIG. 2 It depicts a block diagram more specifically illustrating an exemplary structure of a crisis/crisis impact acquisition unit 6.

FIG. 3 It depicts a block diagram more specifically illustrating an exemplary structure of the crisis/crisis impact acquisition unit 6.

FIG. 4 It depicts a flowchart illustrating exemplary operations of the crisis information delivery device according to the first exemplary embodiment before a crisis breaks out.

FIG. 5 It depicts a flowchart illustrating exemplary operations of the crisis information delivery device according to the first exemplary embodiment when a crisis breaks out.

FIG. 6 It depicts a flowchart illustrating an exemplary processing flow of a diagram generation processing according to the first exemplary embodiment.

FIG. 7 It depicts a block diagram illustrating other exemplary structure of the first exemplary embodiment.

FIG. 8 It depicts an explanatory diagram illustrating exemplary information on relevant objects stored in a user/relevant object storage unit 2.

FIG. 9 It depicts an explanatory diagram illustrating an image of a processing of finding an angle by a positional relationship calculation unit 3.

FIG. 10 It depicts an explanatory diagram illustrating exemplary crisis impacts between a user and relevant objects.

FIG. 11 It depicts a schematic diagram schematically illustrating an exemplary processing of arranging a user and a crisis by a diagram generation unit 5.

FIG. 12 It depicts a schematic diagram schematically illustrating an exemplary processing of arranging relevant objects by the diagram generation unit 5.

FIG. 13 It depicts a schematic diagram schematically illustrating other exemplary drawing processing by the diagram generation unit 5.

FIG. 14 It depicts a schematic diagram schematically illustrating other exemplary drawing processing by the diagram generation unit 5.

FIG. 15 It depicts an explanatory diagram illustrating a display image of a generated diagram.

FIG. 16 It depicts a block diagram illustrating an exemplary structure of a crisis information delivery device according to a second exemplary embodiment.

FIG. 17 It depicts a flowchart illustrating exemplary operations of the crisis information delivery device according to the second exemplary embodiment when a crisis breaks out.

FIG. 18 It depicts a flowchart illustrating an exemplary processing flow of a map display generation processing according to the second exemplary embodiment.

FIG. 19 It depicts an explanatory diagram illustrating a display image of map display.

FIG. 20 It depicts a block diagram illustrating an exemplary structure of a crisis information delivery device according to a third exemplary embodiment.

FIG. 21 It depicts a flowchart illustrating exemplary operations of the crisis information delivery device according to the third exemplary embodiment when a crisis breaks out.

FIG. 22 It depicts an explanatory diagram illustrating a display image of a diagram according to the third exemplary embodiment.

FIG. 23 It depicts a block diagram illustrating a characteristic component in a crisis information delivery device according to the present invention.

FIG. 24 It depicts a block diagram illustrating characteristic components in a crisis information delivery system according to the present invention.

FIG. 25 It depicts a block diagram illustrating a characteristic component in a user terminal according to the present invention.

### DESCRIPTION OF EMBODIMENTS

Exemplary embodiments according to the present invention will be described below with reference to the drawings.

### First Exemplary Embodiment

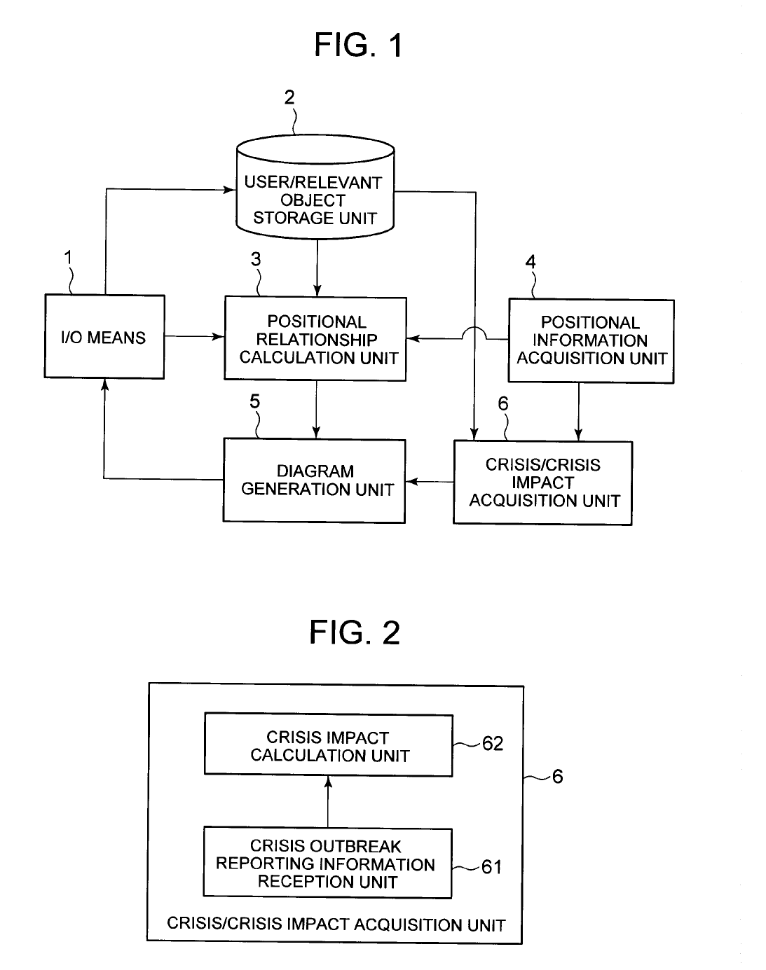

FIG. 1 is a block diagram illustrating an exemplary structure of a crisis information delivery device according to a first exemplary embodiment of the present invention. The crisis information delivery device illustrated in FIG. 1 includes an I/O means 1, a user/relevant object storage unit 2, a positional relationship calculation unit 3, a positional information acquisition unit 4, a diagram generation unit 5, and a crisis/crisis impact acquisition unit 6.

The I/O means 1 has an input means for inputting user's operation information such as mouse, keyboard, touch panel or key panel, and an output means such as display, and inputs and outputs various items of data. The I/O means 1 further includes a means for inputting/outputting data to/from other device at a network destination or a connected peripheral device. The crisis information delivery device may be a cell phone, Smartphone, PC, digital signage, or the like including both the input means and the output means, for example.

The user/relevant object storage unit 2 stores therein information for identifying a user and information on relevant objects for the user. Herein, the relevant objects are evacuation spots, place of work, home, and the like. They may be broadly objects required when a crisis breaks out, objects and persons in close relationship with user's daily life, or objects for user's property. The information on relevant objects is stored such as information for identifying them, names, and positional information or ID for acquiring positional information. The information on relevant objects may be input by the user via the I/O means 1, or a system manager may previously input information on evacuation spots in a residence region for information on evacuation spots near user's position or may acquire it via a network depending on user's current position as needed.

The positional information acquisition unit 4 acquires user's positional information when a crisis breaks out. The positional information may be acquired by use of a well-known observation technique such as GPS. When the crisis information delivery device is conducted by a portable terminal owned by the user, the positional information of the portable terminal may be acquired as user's positional information, or the user's positional information may be received from a system serving to deliver positional information of previously-registered users. Recognition of the outbreak of a crisis may be assumed as reception of information such as alarm by the device for reporting the outbreak of a crisis (which will be denoted as crisis outbreak reporting information).

When an object or person not in a fixed position such as user's family is registered as relevant object, the positional information acquisition unit 4 may acquire the positional information on the relevant object together. When the source of the crisis cannot be specified from the crisis outbreak reporting information, the positional, information on the source of the crisis may be acquired together. The source of the crisis may be acquired by use of the map information based on place names or the like indicated in the crisis outbreak reporting information, for example.

The positional relationship calculation unit 3 calculates a direction toward the crisis and directions toward the relevant objects with reference to the position of the user, respectively, based on the positional information acquired by the positional information acquisition unit 4 (positional information on the user, the crisis and the relevant objects) and the positional information on the relevant objects stored in the user/relevant object storage unit 2. The directions may be collectively called direction from the position of the user below.

The crisis/crisis impact acquisition unit 6 acquires contents of the crisis (such as type of crisis, outbreak position, outbreak time, and magnitude), and crisis impacts as the degrees of hazard at the user's position and the relevant objects' positions. The crisis impact is earthquake intensity, inundation depth, wind velocity and the like, and the measurement values thereof may be used or the measurement values may be converted into a difference between the height of a tsunami and the height above sea level, and the like.

FIG. 2 is a block diagram more specifically illustrating an exemplary structure of the crisis/crisis impact acquisition unit 6. As illustrated in FIG. 2, the crisis/crisis impact acquisition unit 6 may include a crisis outbreak reporting information reception unit 61 and a crisis impact calculation unit 62. The crisis outbreak reporting information reception unit 61 receives crisis outbreak reporting information via an alarm for notifying the outbreak of a crisis, and acquires the contents of the crisis included in the crisis outbreak reporting information. Further, the crisis impact calculation unit 62 calculates the crisis impacts at a position of the user and a position of each relevant object based on the contents of the crisis acquired by the crisis outbreak reporting information reception unit 61, at least the positional information of the user acquired by the positional information acquisition unit 4, and the positional information of the relevant objects stored in the user/relevant object storage unit 2. The crisis impact calculation unit 62 may calculate the crisis impacts by use of the equations formulated by a well-known observation technique.

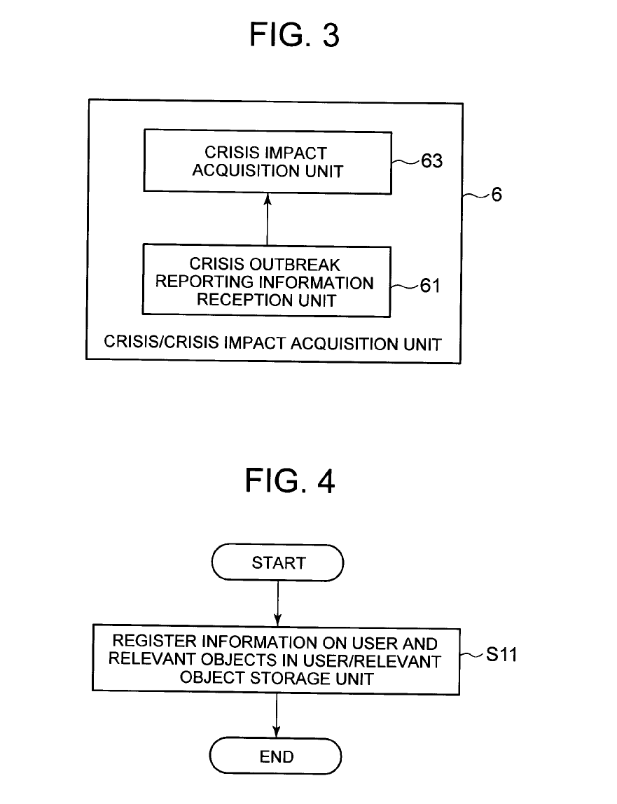

Further, FIG. 3 is a block diagram illustrating other exemplary structure of the crisis/crisis impact acquisition unit 6. As illustrated in FIG. 3, the crisis/crisis impact acquisition unit 6 may include a crisis impact acquisition unit 63 instead of the crisis impact calculation unit 62 illustrated in FIG. 2. The crisis impact acquisition unit 63 acquires the crisis impacts at a position of the user and a position of each relevant object based on the contents of the crisis acquired by the crisis outbreak reporting information reception unit 61, at least the positional information of the user acquired by the positional information acquisition unit 4, and the positional information of the relevant objects stored in the user/relevant object storage unit 2. The crisis impact acquisition unit 63 may acquire the degrees of hazard at the positions of the user and each relevant object from the system for delivering the degrees of hazard at designated positions around a crisis when the crisis breaks out, and may acquire them as the crisis impacts, for example.

The diagram generation unit 5 arranges the user, the crisis and the relevant objects on a plane such that their crisis impacts are indicated in the distances from the crisis on the plane while correctly reflecting the directions from the position of the user to the crisis and the relevant objects calculated by the positional relationship calculation unit 3. In other words, the crisis, the user and evacuation spots to be displayed are arranged on the plane while the directions from the user are kept, and the objects to be displayed other than the crisis are arranged in the distances from the crisis depending on the crisis impacts of the objects to be displayed.

The diagram generation unit 5 may express the crisis impacts and the crisis contents at each position on the plane. The method for expressing a crisis impact suitably employs color hue, a value, and the like, but is not limited thereto. The method for expressing crisis contents suitably employs character information on the outline of the crisis around the source on the plane or character information on the impacts or damages at the points near the user and the relevant objects on the diagram, but is not limited thereto.

The thus-generated diagram is output to the I/O means 1 to be presented to the user.

With the above structure, the user/relevant object storage unit 2 is realized by a storage device, for example. The positional relationship calculation unit 3, the positional information acquisition unit 4, the diagram generation unit 5, and the crisis/crisis impact acquisition unit 6 are realized by an information processing device such as CPU.

The example illustrated in FIG. 1 demonstrates that one device performs all the processings of managing information input for the user and relevant objects, acquiring the contents of a crisis, acquiring positional information of the user, crisis and relevant objects to be displayed, calculating the directions from the position of the user, acquiring the crisis impacts, and generating and outputting a diagram, but all or part of the processings may be performed by other device. That is, various processings performed by the present crisis information delivery device may be realized by a server-client type crisis information delivery system. For example, the user/relevant object storage unit 2 may be provided in the server, and other processing units and information acquisition units from the storage unit may be provided in the user terminal. Further, for example, the processing units other than the I/O means 1, and the storage unit may be provided in the server, the user terminal may have only the function of transmitting operation information from the user to the server and the function of receiving and displaying the information (such as diagram) output from the server, and other processings may be all performed in the server. The function distribution is not limited to the example.

The operations according to the present exemplary embodiment will be described below. The operations according to the present exemplary embodiment can be classified into two phases, or before a crisis breaks out and when a crisis breaks out. At first, the operations before a crisis breaks out will be described with reference to FIG. 4. FIG. 4 is a flowchart illustrating exemplary operations of the crisis information delivery device according to the present exemplary embodiment before a crisis breaks out. As illustrated in FIG. 4, before a crisis breaks out, information for identifying the user or information on relevant objects is input via the I/O means 1, and the input information is stored in the user/relevant object storage unit 2 (step S11).

The information for identifying a user is registered by use of information for identifying an individual device having the I/O means used by the user, but the user may register his/her ID. The method for registering a relevant object may be selecting from a list of previously-stored relevant objects and positional information or user's inputting the name and positional information of a relevant object. Further, the method for inputting positional information may be inputting an address or selecting a point on a map. However, it is not limited thereto.

For example, the user may input information for identifying the user or information on relevant objects by preparing a registration screen and displaying the registration screen when the service starts or in response to a user's menu operation. Not only with the method via the registration screen, when information on evacuation spots is received from other device, the information on evacuation spots may be registered as relevant objects in the user/relevant object storage unit 2.

In this way, before a crisis breaks out, necessary information is stored in the user/relevant object storage unit 2 in a preparation phase for outbreak. No relevant object may be registered, and in this case, the operations may be performed with no relevant object when a crisis breaks out. When a server device or the like for managing a plurality of users is not present or when the crisis information delivery device performs all the operations solely, the information for identifying the users may be omitted.

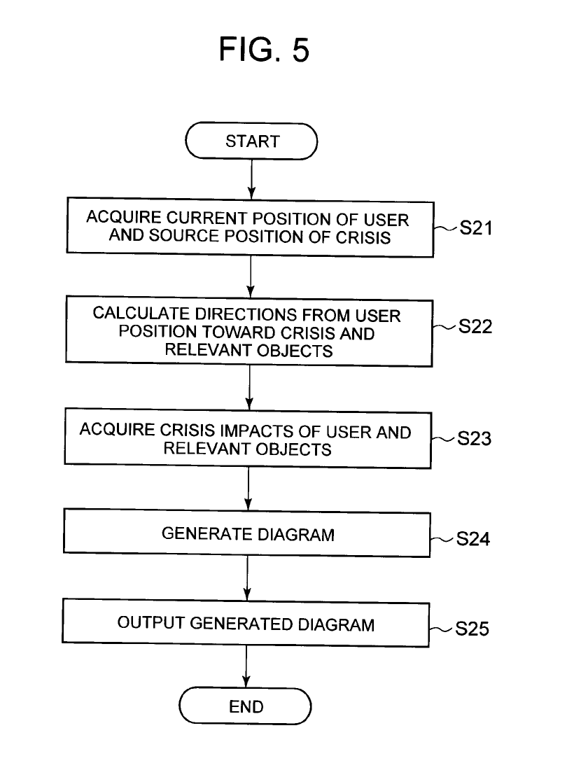

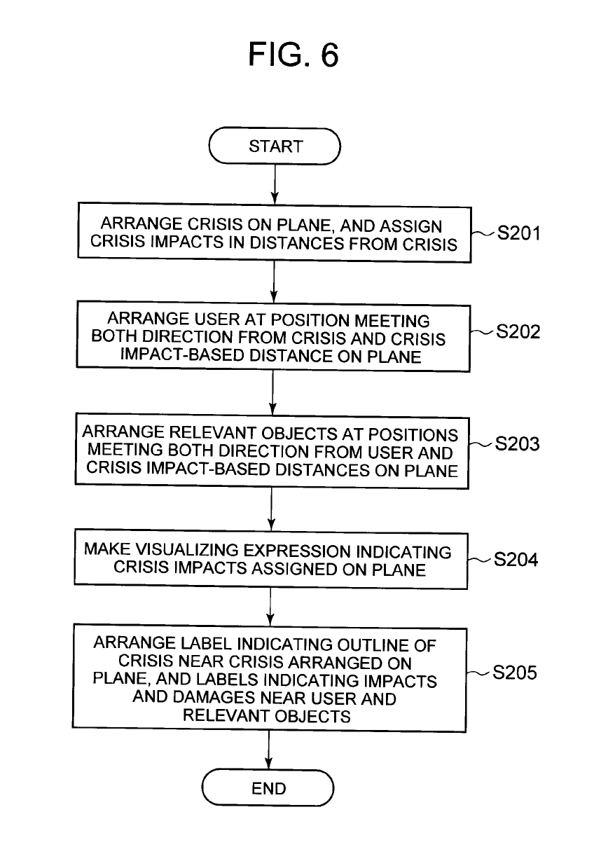

The operations when a crisis breaks out will be described below with reference to FIG. 5 and FIG. 6. FIG. 5 is a flowchart illustrating exemplary operations of the crisis information delivery device according to the present exemplary embodiment when a crisis breaks out. FIG. 6 is a flowchart illustrating an exemplary processing flow of a diagram generation processing included in FIG. 5. The operations when a crisis breaks out start on reception of crisis breakout reporting information. The crisis breakout reporting information is an alarm for notifying the breakout of a crisis such as earthquake alarm or tsunami alarm. In the example illustrated in FIG. 5, when the breakout of a crisis is recognized, the positional information acquisition unit 4 first acquires a current position of the user and the source of the crisis (step S21). When the current position of the user matches with the positional information of the I/O means 1, the positional information acquisition unit 4 may acquire the positional information of the I/O means 1 by use of GPS. Further, when the I/O means 1 is realized by a stationary device such as digital signage used by the user, the installation position is previously stored and its information is read thereby to acquire a current position. Herein, if a relevant object whose position is not fixed is present, a position of the relevant object is acquired.

The source of the crisis employs a position at the time of observation. As to a typhoon having a certain range or floods not fixed at a point on the map, its center part or a representative point such as influential part is calculated or acquired. A plurality of representative points may be present, and are set within the predetermined maximum number.

The positional relationship calculation unit 3 then calculates the directions toward the crisis and each relevant object with reference to the position of the user (step S22). Specifically, the positional relationship calculation unit 3 calculates an angle formed by the direction toward the position of the crisis from the position of the user or the direction toward the position of the crisis with reference to the position of the user and a reference direction based on the positional coordinate of the user and the positional coordinate of the crisis. Similarly, an angle formed by the direction toward the position of a relevant object from the position of the user or the direction toward the position of a relevant object with reference to the position of the user and the reference direction is calculated based on the positional coordinate of the user and the positional coordinate of the relevant object.

The crisis/crisis impact acquisition unit 6 then acquires the crisis impacts at the positions of the user and the relevant objects, respectively (step S23). The acquisition method is as previously described, but in the present example, it is assumed that the crisis impact is a real number and each value can be assigned on the number line with a predetermined size.

When the directions from the user toward the crisis and each relevant object and the crisis impacts of the user and each relevant object for the crisis are acquired, the diagram generation unit 5 generates a diagram in which the directions from the users and the crisis impacts for the crisis are visualized for the crisis, the user and the relevant objects to be displayed (step S24). A specific diagram generation method will be described below.

When a diagram is generated, the generated diagram is output via the I/O means 1 (step S25). For example, the diagram generation unit 5 creates a crisis information display screen including the generated diagram and outputs the screen information via the I/O means 1 so that the diagram is displayed to the user. A diagram output means may be provided in addition to the diagram generation unit 5, and the diagram output means may output the generated diagram in a form processable by the I/O means 1.

The diagram generation method by the diagram generation unit 5 will be described below with reference to FIG. 6. In the example illustrated in FIG. 6, the diagram generation unit 5 first generates a region to draw a diagram, more specifically, a virtual drawing space such as Graphics object. The virtual drawing space will be called “drawing region” below. In the present exemplary embodiment, the drawing region is assumed as a plane, and the crisis, the user and the relevant objects to be displayed (more specifically, corresponding display icons) are arranged on the plane. In describing the operations, to express that the drawing work is performed on the drawing region, that is, the visualizing expression is made on the plane arranging the display icons therein means that an operation corresponding to the drawing work is actually performed on the drawing region via the GUI control and consequently information indicating the drawing result is stored in a memory space corresponding to the drawing region.

In step S201, the crisis is arranged on the plane in the drawing region, and crisis impacts are assigned in the distances from the arranged crisis. More specifically, the display icon for crisis (which will be called crisis icon below) is arranged at one point on the plane in the drawing region, and the crisis impacts are associated with the Euclidean distances from the crisis icon in the drawing region. The mapping for defining the association at this time may be any monotonically decreasing function. That is, any mapping for reversing the order when the objects to be displayed other than the crisis are arranged in order of crisis impact may be possible.

The user is then arranged on the plane (step S202). In step S202, the display icon for user (which will be called user icon below) is arranged at a position meeting both the direction from the actual position of the user toward the position of the crisis and the distance from the crisis icon on the plane corresponding to the crisis impact at the actual position of the user. Since the crisis impacts are associated with the distances from the crisis icon on the plane in step S201, the user icon may be first arranged at a distance from the crisis icon according to the crisis impact of the user. That is, the crisis impact of the user may be reflected on the distance between the user icon and the crisis icon. Additionally, an angle formed between the direction from the user icon toward the crisis icon and the reference direction may be an angle formed between the direction from the actual position of the user toward the crisis and the reference direction in order to meet the direction from the actual position of the user toward the position of the crisis on the plane. Consequently, the arrangement position of the user icon is defined on the plane.

Similarly, each relevant object is arranged on the plane (step S203). In step S203, the relevant objects for the user stored in the user/relevant object storage unit 2 are arranged as the user is arranged. That is, for each relevant object for the user stored in the user/relevant object storage unit 2, the display icon for the relevant object (which will be called relevant object icon below) is arranged at a position meeting both the direction from the actual position of the user toward the position of the relevant object and the distance from the crisis icon on the plane corresponding to the crisis impact at the actual position of the relevant object. Herein, the relevant objects to be displayed may be limited to the relevant objects for the user stored in the user/relevant object storage unit 2, whose crisis impacts are equal to or more than a predetermined value.

If the crisis impacts are simply assigned in the distances from the crisis icon, some relevant objects cannot meet both the direction from the actual position of the user toward the position of a relevant object and the distance from the crisis icon on the plane corresponding to the crisis impact at the actual position of the relevant object depending on a value of the crisis impact, the nature of an index to be considered or a combination method. For example, when a relevant object has a higher crisis impact than the crisis impact of the user, it is arranged closer to the crisis icon than to the user icon, but a curved line indicating the possible arrangement positions may not contact with a line segment indicating the direction from the arrangement position of the user icon toward the arrangement position of the relevant object icon. In such a case, the mapping into a distance of crisis impact may be changed such that at least they are contact with each other. At this time, different mapping may be employed depending on a direction or different mapping may be employed depending on a value range of the crisis impact. In steps S201 to S203, the arrangement positions of the icons are only determined, and the actual drawing processing may be performed by use of the GUI drawing function.

In this way, the user, the relevant objects and the crisis are completely arranged on the plane depending on the crisis impacts while the directions from the user are maintained.

Further, the diagram generation unit 5 may make visualizing expression indicating a degree of assigned crisis impact on the plane (step S204). It is preferable that the background colors are subjected to gradation or isogram is drawn, but the expression is not limited thereto. Exemplary background colors preferably employ a change in hue of colors depending on the crisis impacts (a strong warm color for a higher value, a weak warm color for a lower value, and the like), a change in α value (lower transparency for a higher value, higher transparency for a lower value, and the like), and the like, but are not limited thereto. Exemplary isogram may be drawn through the points where the user or relevant object is arranged, drawn at certain intervals, and the like, but is not limited thereto.

Further, the diagram generation unit 5 may acquire crisis information from the crisis/crisis impact acquisition unit 6, and arrange the outline thereof near the crisis icon on the plane, and labels indicating impacts and damages at the positions of the user icon and the relevant object icons near them (step S205). Exemplary crisis outline information may be current position of crisis, time of breakout, magnitude, and the like, for example. Exemplary impact and damage information may be crisis impact at the position, presence of damage, degree of damage, and the like. The information is displayed as character information on the plane. The method therefor is suitably to switch display in response to a user's operation (touch operation, pointer-over, switch operation of switching display/hide) or the like, but is not limited thereto.

The diagram generation unit 5 holds the display image of all or part of the drawing region subjected to the drawing processing as a diagram to be displayed. Any form of the diagram is possible.

The thus-created diagram is output as information displayable to the user via the I/O means 1, thereby being presented to the user. The information displayable to the user may be a screen including the Graphics objects held as a diagram, or image data in a predetermined form.

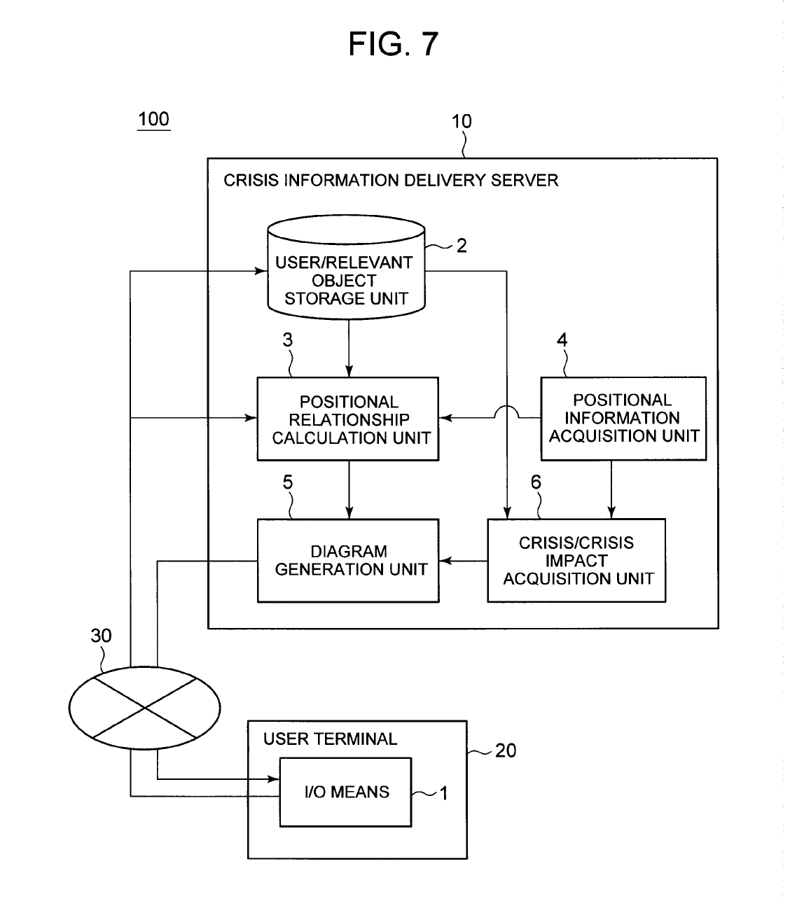

The operations according to the present exemplary embodiment will be described below by use of specific examples. There will be described below an example in which the I/O means 1 is realized by a user terminal such as Smartphone used by the user and other processing units are realized by a server device connected to the user terminal via a network. That is, as illustrated in FIG. 7, the description will be made assuming that the present exemplary embodiment is mounted as a crisis information delivery system 100.

The crisis information delivery system 100 illustrated in FIG. 7 includes a user terminal 20 and a crisis information delivery server 10, which are connected with each other via a network 30. The user terminal 20 includes the I/O means 1. The crisis information delivery server 10 includes the user/relevant object storage unit 2, the positional relationship calculation unit 3, the positional information acquisition unit 4, the diagram generation unit 5, and the crisis/crisis impact acquisition unit 6. The user/relevant object storage unit 2 may be mounted as a different device. In such a case, the crisis information delivery server 10 may include a user/relevant objet information acquisition unit instead of the user/relevant object storage unit 2.

At first, before a crisis breaks out, the user accesses the crisis information delivery server 10 on the network and registers the user and relevant objects in the user/relevant object storage unit 2 by use of the user terminal 20 as the I/O means 1.

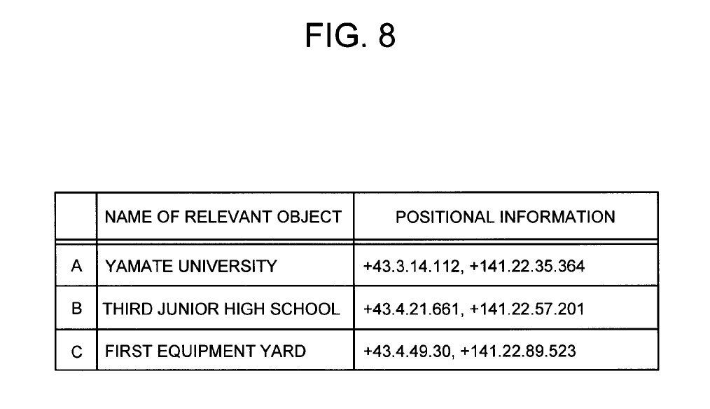

Personal information and terminal-specific identification information for user registration are transmitted to the crisis information delivery server 10. Subsequently, information on the relevant objects is registered. In the present example, neighboring evacuation spots are automatically registered as relevant places. Herein, three places including Yamate University, third junior high school and first equipment yard are registered. In the following, Yamate University, third junior high school and first equipment yard are called relevant object A, relevant object B and relevant object C, respectively. The positional information is expressed by the coordinates of east longitude and north latitude, such as +43.3.14.112, +141.22.35.364. The information on the relevant objects stored in the user/relevant object storage unit 2 in the present example is illustrated in FIG. 8. FIG. 8 is an explanatory diagram illustrating exemplary information on the relevant objects stored in the user/relevant object storage unit 2.

The description will be subsequently made assuming that a tsunami breaks out due to an earthquake when a crisis breaks out. When the outbreak of a tsunami is observed and a tsunami alarm is issued, the crisis/crisis impact acquisition unit 6 in the crisis information delivery server 10 receives the alarm and observation data. When the crisis/crisis impact acquisition unit 6 receives the alarm, the positional information acquisition unit 4, which thereby recognizes the outbreak of a crisis, acquires the coordinate of the seismic source as the source of the tsunami from the received alarm and observation data or based on the information thereof. The positional information acquisition unit 4 further acquires a current position of the user. In the present example, positional information is requested to the user terminal 20, and the requested user terminal 20 measures its position by use of GPS and transmits it to the crisis information delivery server 10. In this way, the positional information acquisition unit 4 acquires a current position of the user.

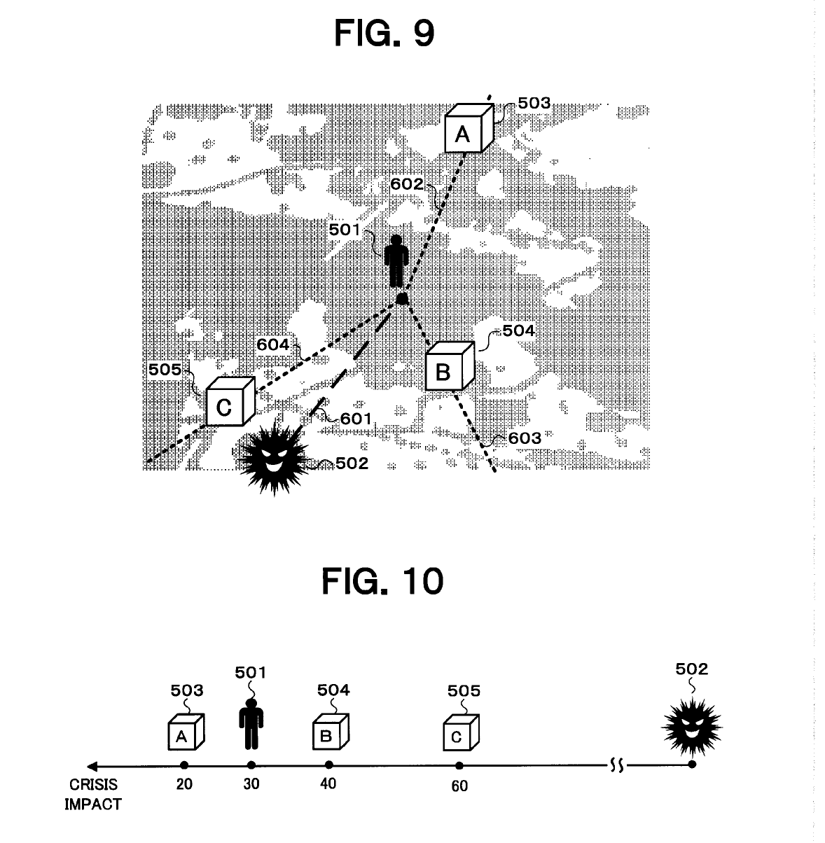

The positional relationship calculation unit 3 acquires the positional coordinates of the user, the relevant objects and the crisis from the user/relevant object storage unit 2 and the positional information acquisition unit 4, and calculates the directions (angles) from the position of the user toward the crisis and the relevant objects. An image diagram expressing the processing of finding an angle is illustrated in FIG. 9. FIG. 9 is an explanatory diagram illustrating an image of the processing of finding an angle by the positional relationship calculation unit 3.

In FIG. 9, a user icon 501, a crisis icon 502, and relevant object icons 503 to 505 are arranged on the map by use of their positional coordinates. A broken line 601 indicates the direction toward the crisis from the position of the user, a broken line 602 indicates the direction toward the relevant object A from the position of the user, a broken line 603 indicates the direction toward the relevant object B from the position of the user, and a broken line 604 indicates the direction toward the relevant object C from the position of the user. The positional relationship calculation unit 3 takes a reference relative to a direction from the position of the user, and acquires an angle formed by the reference and each broken line.

The crisis/crisis impact acquisition unit 6 acquires the outline information on the crisis such as source of tsunami, time of outbreak, and magnitude. The crisis impacts at the positions of the user and the relevant objects are acquired or calculated. In the present example, a predicted inundation depth calculated based on the height of the tsunami and the height above sea level is calculated as a crisis impact. The icons to be displayed are arranged and schematically indicated on the number line depending on the calculation results of the crisis impacts of the user and the relevant objects in FIG. 10. FIG. 10 illustrates that the crisis impacts of the relevant object C, the relevant object B, the user 501, and the relevant object A are higher in this order in the present example and the values thereof are 60, 40, 30, and 20, respectively. In FIG. 10, the icons of the user and the relevant objects are arranged on the number line to reflect the values.

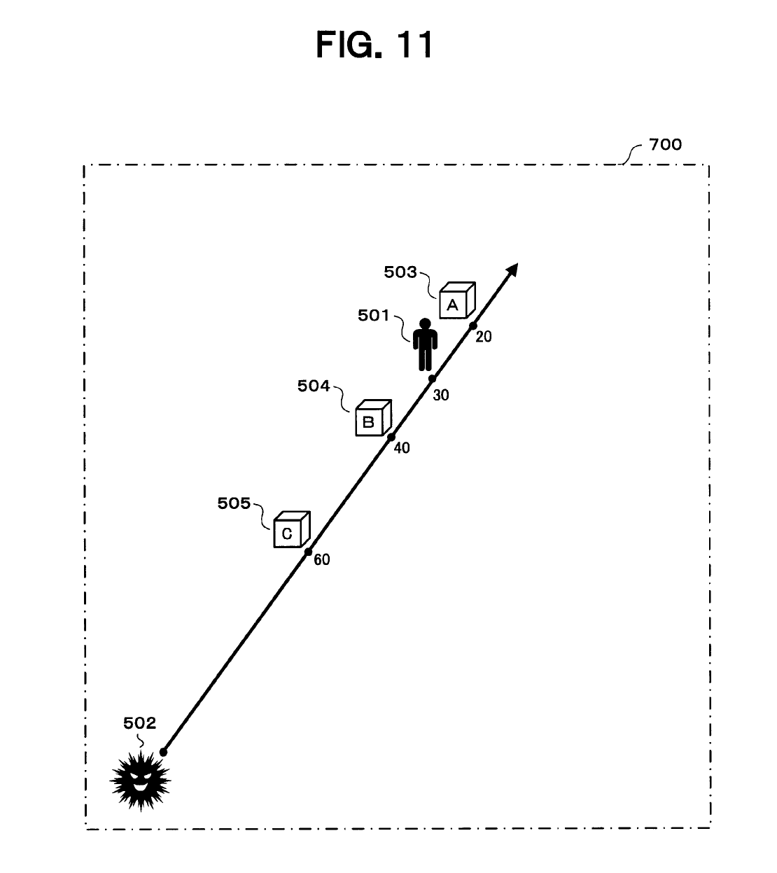

When the contents of the crisis, the directions toward the crisis and the relevant objects from the position of the user, and the crisis impacts of the user and the relevant objects are acquired, the diagram generation unit 5 first arranges the crisis icon 502 on a plane 700 in the drawing region, and associates the positions of the icons such that the crisis impacts of the user and the relevant objects monotonically decrease relative to the distances from the crisis icon 502 as illustrated in FIG. 11. FIG. 11 is a schematic diagram schematically illustrating an exemplary processing of arranging the user and the crisis by the diagram generation unit 5. In FIG. 11, since the crisis impact of the relevant object A is 20, the crisis impact of the user is 30, the crisis impact of the relevant object B is 40, and the crisis impact of the relevant object C is 60, the icons of the user and the relevant objects are arranged such that they are farther from the crisis icon 501 in this order. At this time, the direction toward the crisis from the position of the user is reflected on the arrangement position of the user icon in addition to the distance from the crisis icon depending on the crisis impact.

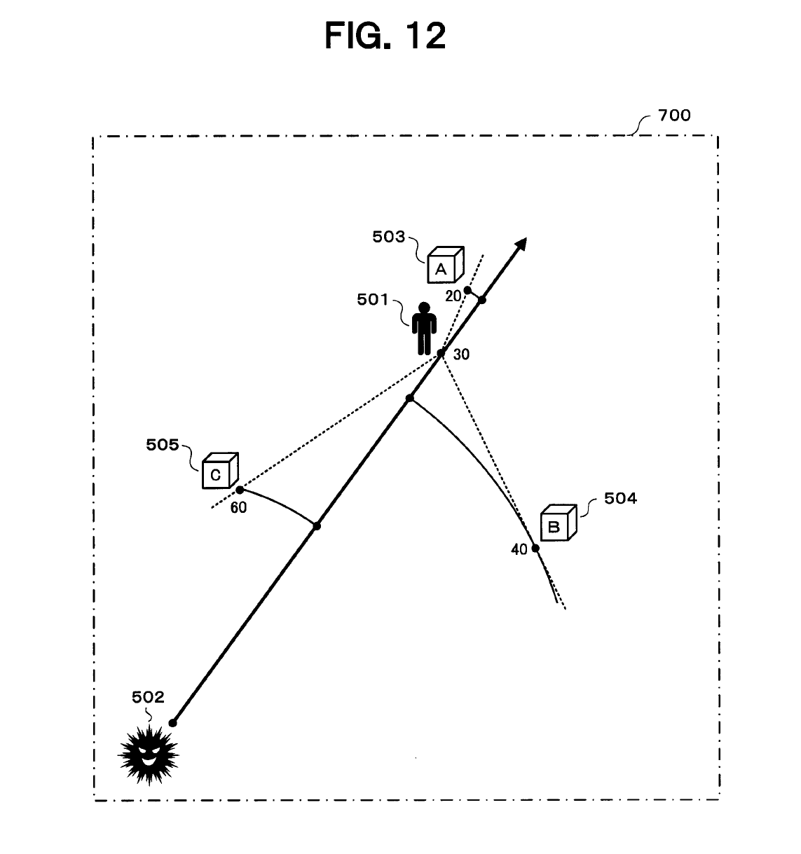

Thereafter, as illustrated in FIG. 12, the arrangement positions of the relevant object icons 503 to 505 are assumed to reflect not only the distances from the crisis icon depending on the crisis impacts but also the directions toward the relevant objects from the position of the user calculated in the positional relationship calculation unit 3. In this way, the arrangement positions of the user icon 502 and the relevant object icons 503 to 505 are defined relative to the crisis icon 502 on the plane 700. FIG. 12 is a schematic diagram schematically illustrating an exemplary processing of arranging the relevant objects by the diagram generation unit 5.

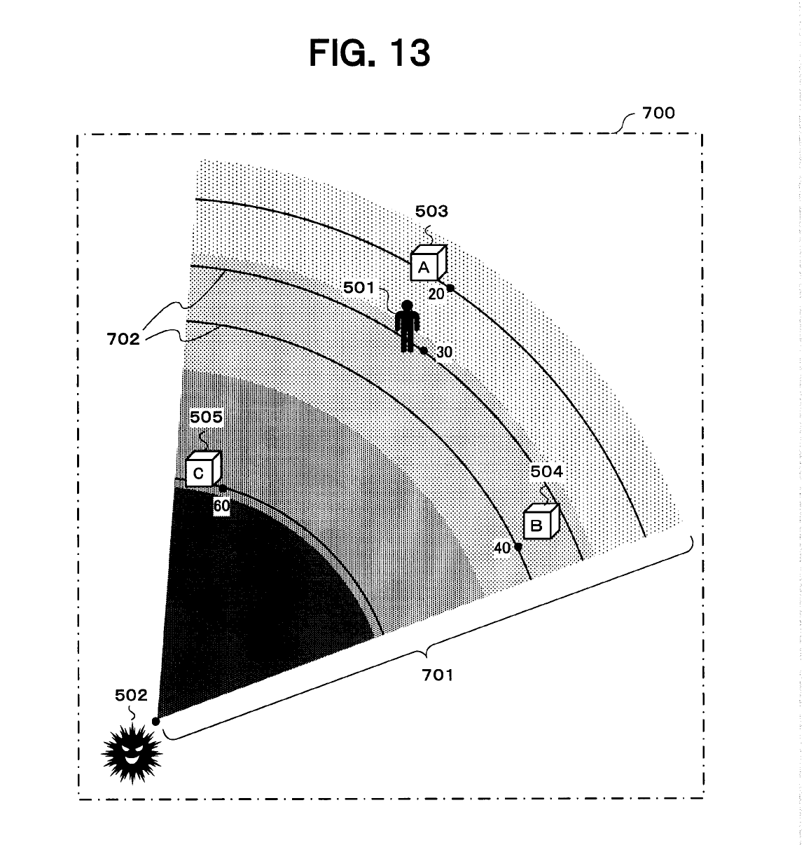

Subsequently, the diagram generation unit 5 draws background 701 and contours 702 illustrated in FIG. 13 on the plane 700. FIG. 13 is a schematic diagram schematically illustrating an exemplary processing of drawing background, isogram and the like by the diagram generation unit 5. The example illustrated in FIG. 13 is schematic, in which the hue in the background 701 is changed from a strong warm color to a weak warm color depending on a distance from the crisis icon 502 and the brightness is continuously changed from low to high. FIG. 13 illustrates the intensity of a warm color of the hue and the brightness level depending on the density of a shaded part. That is, as the shaded part is stronger, the warm color of the hue is stronger and the brightness is lower. With the background expressed in this way, a portion with a higher crisis impact is strongly colored and a portion with a lower crisis impact is lightly colored so that the crisis impacts can be intuitively understood by the colors.

In the example illustrated in FIG. 13, the contours 702 connecting the points with a constant distance from the crisis or a constant crisis impact are drawn. In the present example, the isogram is drawn to pass through the arrangement points of the user icon and the relevant object icons. The isogram is drawn in this way so that the crisis impacts of the user and the relevant objects can be quickly grasped. Further, in the present example, only the part necessary to contain the crisis icon, the user icon and the relevant object icons to be displayed is drawn together with the background 701 and the isogram 702. The drawing range is narrowed in this way so that the diagram can be displayed as largely as possible in a limited display space.

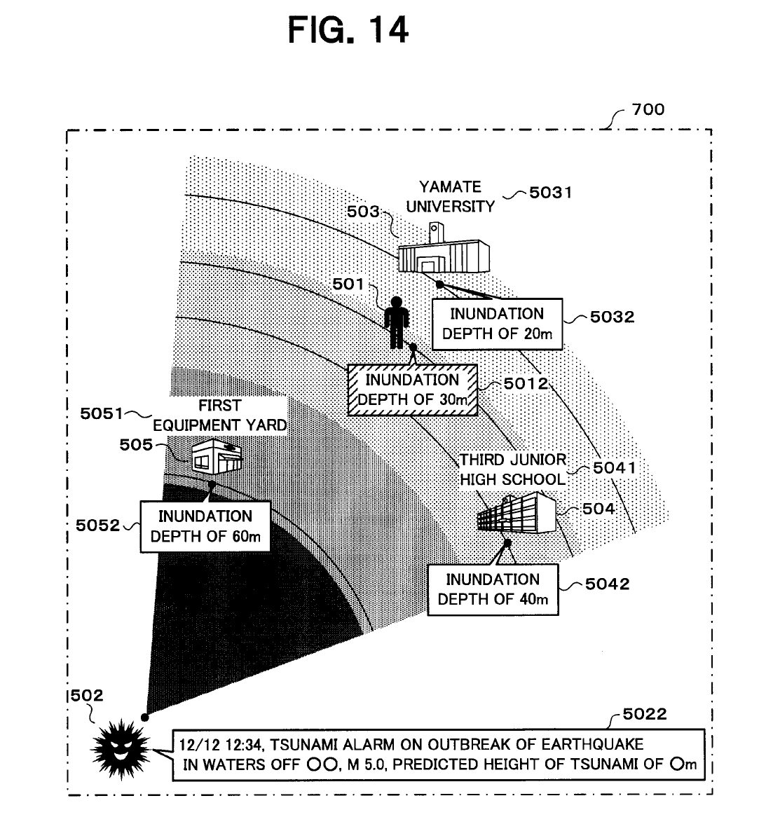

Subsequently, the diagram generation unit 5 may arrange the labels for the outline of the crisis and the impacts and damages at the positions of the user and the relevant objects near their icons on the plane 700 based on the contents of the crisis acquired by the crisis/crisis impact acquisition unit 6 and the predictive information on the impacts and damages at the positions of the user and the relevant objects as illustrated in FIG. 14. In the present example, label 5022 indicates the outline of the crisis such as outbreak time of earthquake as the source of tsunami, magnitude of earthquake, and outbreak position of tsunami. Label 5012 indicates an inundation depth as tsunami damage for the impact and damage at the position of the user. The information on the impacts and damages at the positions of the relevant objects are similarly indicated in label 5032, label 5042, and label 5052, respectively. The name of a relevant object is also displayed together.

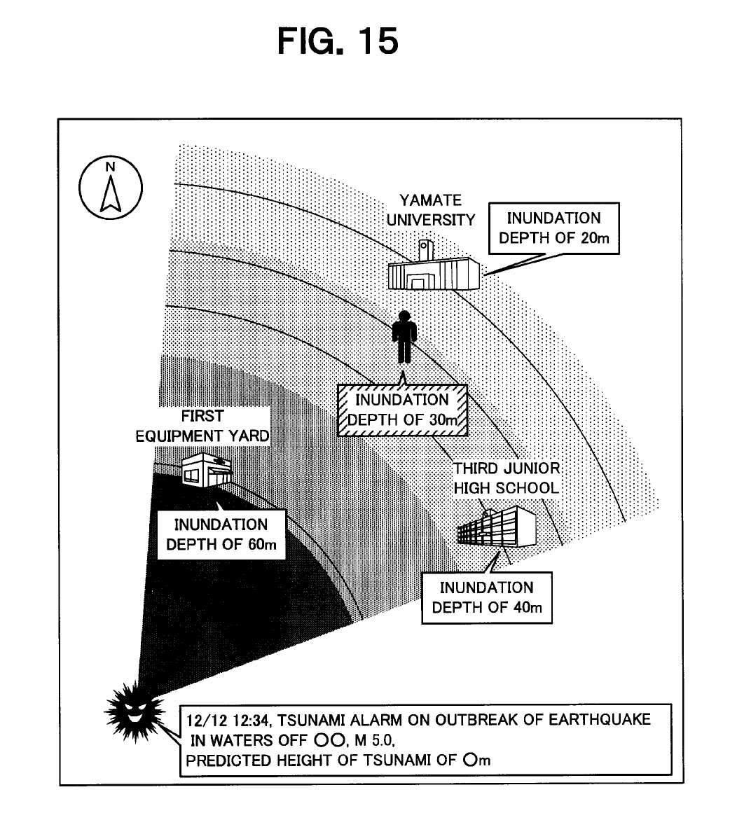

When the drawing processing on the drawing region is all completed, all or part of the display image is assumed as a diagram to be displayed, and the diagram is converted into displayable information on the user terminal 20, and is transmitted to the user terminal 20. The user terminal 20 outputs the received information to the I/O means 1 to display the diagram to the user. For example, the user terminal 20 is assumed to be downloaded with a client application corresponding to the present system, and information on the screen including the diagram may be transmitted in a predetermined format to the client application. FIG. 15 is an explanatory diagram illustrating a display image (exemplary output result) of the diagram generated in the present example. As illustrated in FIG. 15, the diagram may include an orientation mark such that it can be seen that the directions are kept constant in the diagram.

As described above, according to the present exemplary embodiment, if the user confirms the diagram delivered according to the present exemplary embodiment together with the crisis alarm sound or the like, he/she can intuitively recognize how much the crisis influences himself/herself or how much he/she is involved in the crisis, and can immediately take an initial action such as evacuation to a safe evacuation spot (Yamate University as the relevant object A in the example of FIG. 15). This is because the objects to be displayed are limited to the minimum and the objects to be displayed are visualized depending on a degree of crisis impact while not the geographical distance among the geographical information but the directions essentially required for taking an action such as evacuation are kept.

Thus, even if a crisis actually breaks out in a very short time or a person involved in the crisis cannot keep calm when the crisis breaks out, a degree of impact on himself/herself can be understood and a proper action for the crisis can be promoted.

### Second Exemplary Embodiment

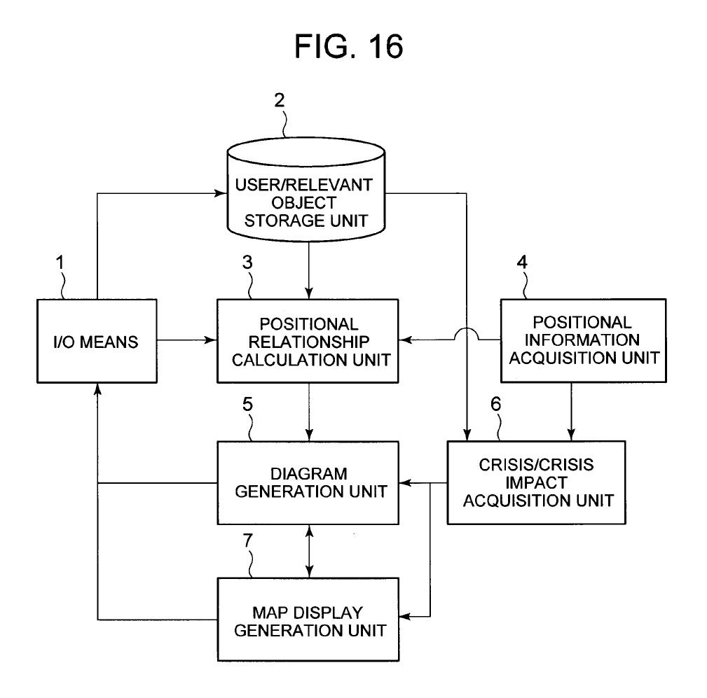

A second exemplary embodiment according to the present invention will be described below. FIG. 16 is a block diagram illustrating an exemplary structure of a crisis information delivery device according to the second exemplary embodiment of the present invention. The crisis information delivery device illustrated in FIG. 16 is different from the crisis information delivery device according to the first exemplary embodiment illustrated in FIG. 1 in that a map display generation unit 7 is provided. Other components are the same as those in the first exemplary embodiment, and thus are denoted with the same reference numerals as in FIG. 1 and the description thereof will be omitted.

The map display generation unit 7 acquires map information corresponding to a current position of the user, and generates map display for displaying the arrangements and crisis impacts the user and relevant objects on the map. More specifically, the map display is a diagram in which a map image is included in background display and objects to be displayed are arranged according to a positional relationship on the map. A diagram on the map generated according to the present exemplary embodiment will be called “map display” below, and “diagram” simply described herein indicates a diagram generated in the same method as the first exemplary embodiment.

The operations according to the present exemplary embodiment will be described below. The operations according to the present exemplary embodiment can be also classified into two phases, or before a crisis breaks out and when a crisis breaks out, but the operations before a crisis breaks out are the same as in the first exemplary embodiment, and thus the description thereof will be omitted.

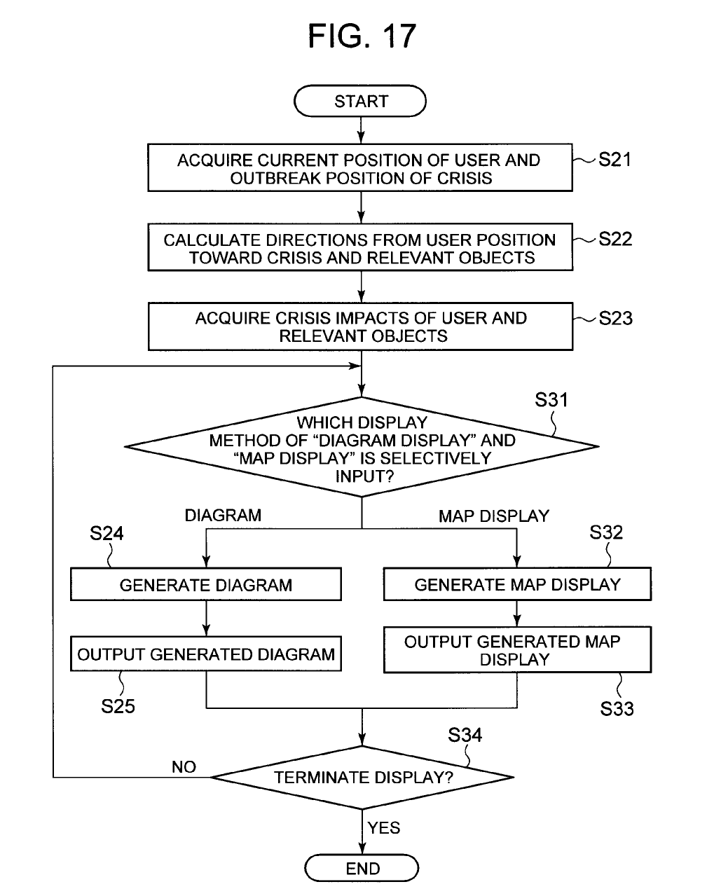

FIG. 17 is a flowchart illustrating exemplary operations of the crisis information delivery device according to the present exemplary embodiment when a crisis breaks out. As illustrated in FIG. 17, the present exemplary embodiment is different from the first exemplary embodiment illustrated in FIG. 5 in the operations after step S23. The same operations as in the first exemplary embodiment are denoted with the same reference numerals as in FIG. 5, and the description thereof will be omitted.

In the present exemplary embodiment, the user selects diagram display or map display to be displayed via the I/O means 1 after steps S21 to S23 (step S31). The selective input method is preferably performed with GUI such as hyperlink or button on the screen, but is not limited thereto.

When the diagram display is selected, the same operations as in the first exemplary embodiment are performed (steps S24, S25). Further, what is displayed as an initial status may be previously defined, and the initial status may be displayed in the absence of user's selection.

On the other hand, when the map display is selected in step S31, the map display generation unit 7 generates map display (step S32). A specific map display generation method will be described below.

When map display is generated, the generated map display is output via the I/O means 1 (step S33). For example, the map display generation unit 7 creates a crisis information display screen including the generated map display and outputs the screen information via the I/O means 1 thereby to present the map display to the user. Also in the present exemplary embodiment, an output means for collectively performing the output processings may be provided, and the output means may convert and output either the generated map display or diagram in a form processable by the I/O means 1 in a designated display method. In the present exemplary embodiment, selective input for alternately switching diagram display and map display is enabled by the input means 1 at the same time with display.

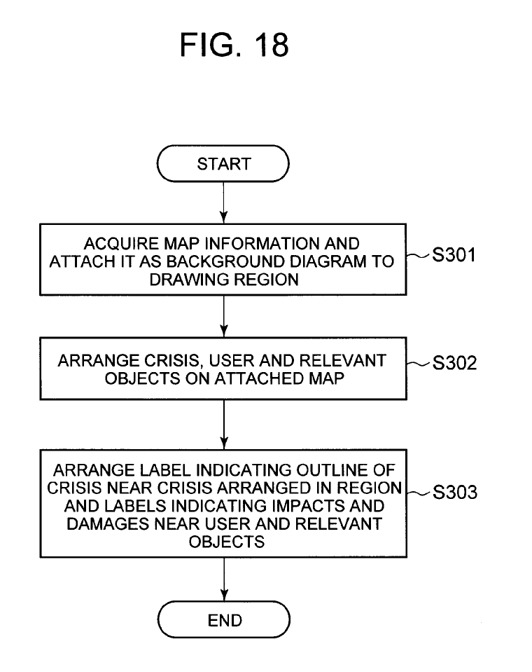

FIG. 18 is a flowchart illustrating an exemplary processing flow of the map display generation processing by the map display generation unit 7. As illustrated in FIG. 18, the map display generation unit 7 first generates a region for drawing map display, more specifically a virtual drawing space such as Graphics object. The virtual drawing space will be called “drawing region” below.

In step S301, the map display generation unit 7 acquires map information from an existing map database or the like, and attaches a map image expressed by the map information as a background image on the drawing region.

Then, the crisis icon, the user icon and the relevant object icons are arranged on the attached map image based on the acquired coordinates of the source of the crisis, the user, and the relevant objects (step S302).

Subsequently, the map display generation unit 7 acquires crisis information from the crisis/crisis impact acquisition unit 6, and arranges the outline of the crisis near the arranged crisis icon, and the labels indicating the impacts and damages near the user icon and relevant object icons (step S303). Labels indicating the name of a relevant object may be arranged together. When the crisis/crisis impact acquisition unit 6 can acquire the crisis impacts at all the points and range on the map, not only at the user and relevant objects, the colors on the map are preferably changed by hue of colors, a value, and the like depending on the crisis impacts thereby to express the crisis impacts.

The thus-generated map display and diagram are converted into switchable information and are output to the I/O means 1. The switching may be performed by GUI such as hyperlink or button as previously described.

When the selective display switching operation is performed again during display, the processing returns to step S31, and the subsequent processings may be repeatedly performed until the display end operation is performed (step S34).

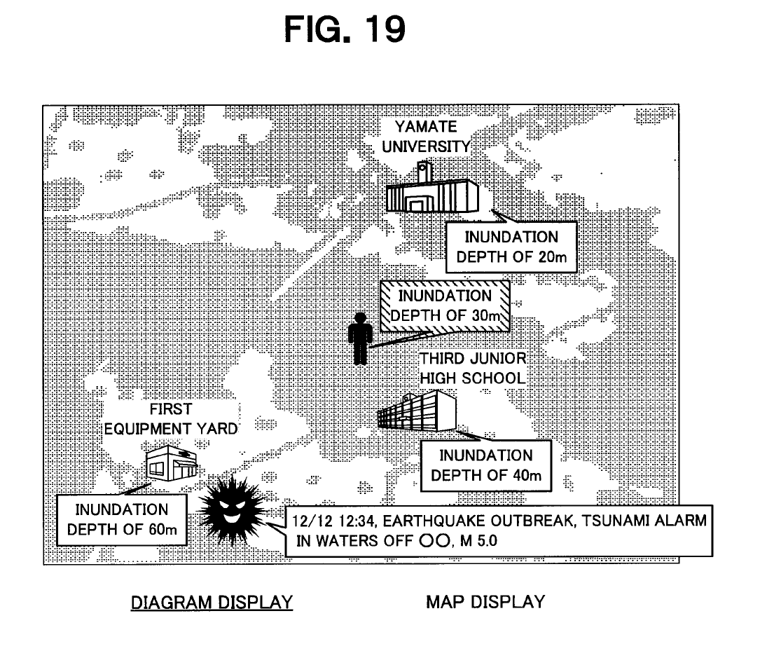

FIG. 19 is an explanatory diagram illustrating a display image (exemplary output result) of map display according to the present exemplary embodiment. FIG. 19 illustrates an example in which the selective input method is performed by use of hyperlink. The map is indistinctly displayed due to the image quality in the present example, but the typical operations for map display, such as scale change, are possible.

According to the present exemplary embodiment, the diagram display and the map display can be alternately switched in this way, and thus both quickly understanding the outline of information by the diagram display and understanding information on evacuation routes and the like by the map display in detail can be enabled.

The method for generating either diagram or map display depending on a display method selected in response to a selectively input display method is illustrated in the flowchart of FIG. 17, but the generation timing and the display switching method are not limited thereto. For example, diagram and map display may be generated irrespective of the presence of selective input thereby to initially perform diagram display. In such a case, alternate switching between diagram display and map display is enabled by the input means 1 at the same time with the diagram display thereby to switch both of them depending on a switching instruction.

The exemplary structure illustrated in FIG. 16 illustrates the example in which one device performs all the processings of managing information input for the user and relevant objects, acquiring the contents of a crisis, acquiring positional information of the user, crisis, relevant objects to be displayed, calculating the directions from the position of the user, acquiring crisis impacts, generating and outputting a diagram, and generating and outputting map display, but also in the present exemplary embodiment, all or part of the processings may be performed in other device. That is, various processings performed by the present crisis information delivery device may be realized by a server-client type crisis information delivery system. For example, the user/relevant object storage unit 2 may be provided in the server, and other processing units, and information acquisition units from the storage unit may be provided in the user terminal. For example, the processing units other than the I/O means 1, and the storage unit may be provided in the server, the user terminal may have only the function of transmitting operation information from the user to the server and the function of receiving and displaying information (such as diagram or map display) output from the server, and other processings may be all performed in the server. The function distribution is not limited to the example.

### Third Exemplary Embodiment

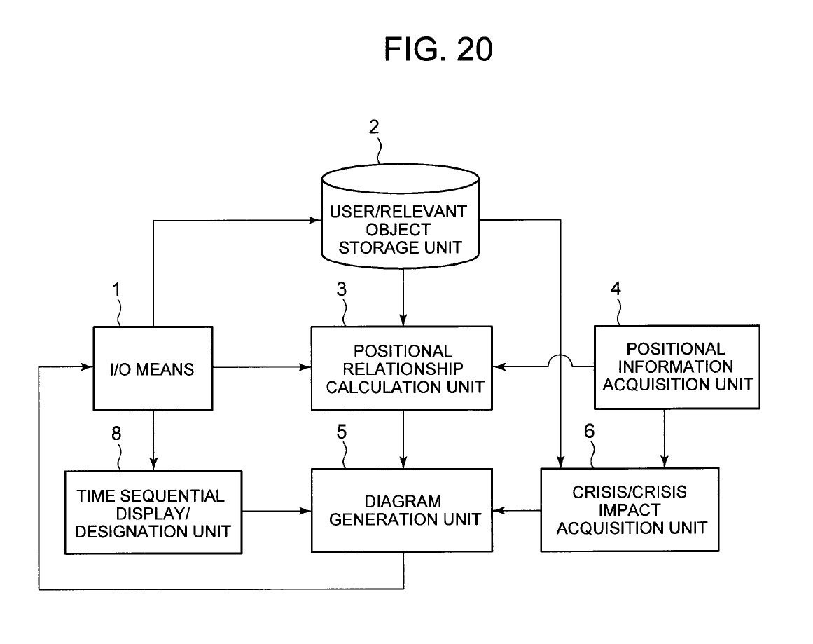

A third exemplary embodiment according to the present invention will be described below. FIG. 20 is a block diagram illustrating an exemplary structure of a crisis information delivery device according to the third exemplary embodiment of the present invention. The crisis information delivery device illustrated in FIG. 20 is different from the crisis information delivery device according to the first exemplary embodiment illustrated in FIG. 1 in that a time sequential display/designation unit 8 is provided. Other components are the same as those in the first exemplary embodiment, and thus are denoted with the same reference numerals as in FIG. 1 and the description thereof will be omitted.

The time sequential display/designation unit 8 designates a time (present, future) to display a diagram, and presents information indicating at which time the diagram being displayed is to the user.

In the present exemplary embodiment, the crisis/crisis impact acquisition unit 6 includes a function of predicting how not only the information on the observed crisis but also the crisis will change or propagate from the observed information in the future.

The operations according to the present exemplary embodiment will be described below. The operations according to the present exemplary embodiment can be classified into two phases, or before a crisis breaks out and when a crisis breaks out. The operations before a crisis breaks out are the same as in the first exemplary embodiment, and thus the description thereof will be omitted.

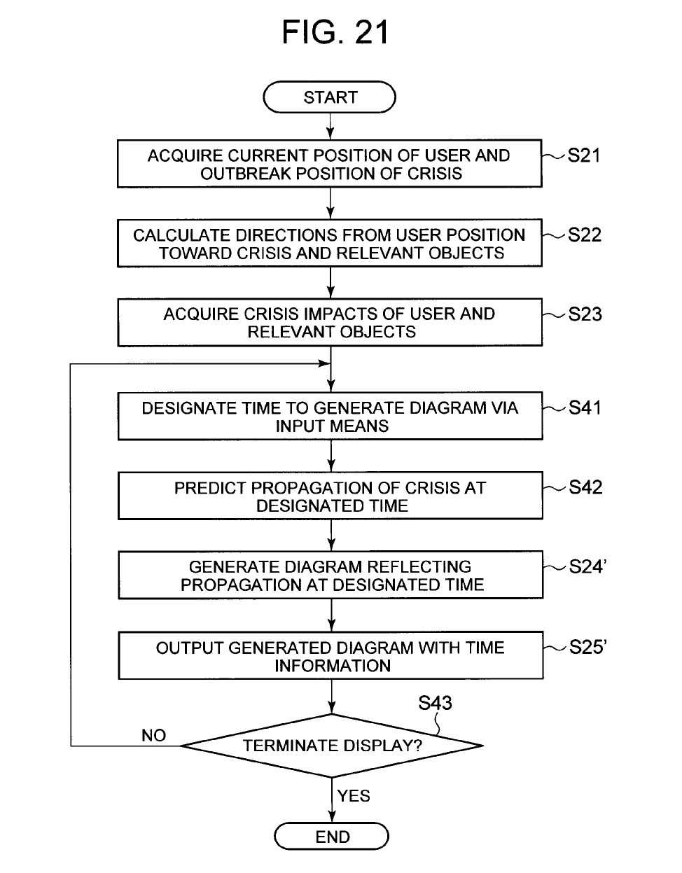

FIG. 21 is a flowchart illustrating exemplary operations of the crisis information delivery device according to the present exemplary embodiment when a crisis breaks out. As illustrated in FIG. 21, the present exemplary embodiment is different from the first exemplary embodiment illustrated in FIG. 5 in the operations after step S23. The same operations as in the first exemplary embodiment are denoted with the same reference numerals as in FIG. 5, and the description thereof will be omitted.

In the present exemplary embodiment, the time sequential display/designation unit 8 causes the user to designate a time for diagram display via the I/O means 1 after steps S21 to S23 (step S41).

The crisis/crisis impact acquisition unit 6 then predicts how the crisis propagates at a designated time (step S42). For the propagation, for example, an arrival area of a crisis such as tsunami or earthquake waveform at the time is predicted by use of the equations formulated by a well-known observation technique, and the degrees of impact or damage when the crisis arrives may be predicted together.

Subsequently, the similar processings to the first exemplary embodiment are performed (step S24′, step S25′). Visualizing expression indicating the presence of crisis impact at a designated time is made on the plane in the diagram generation processing according to the present exemplary embodiment. For example, the diagram generation unit 5 may draw a crisis arrival area at a designated time. When the visualizing expression and the expression method for a degree of crisis impact overlap, the visualizing expression indicating a degree of crisis impact may be performed in other way or may be omitted. When a diagram is displayed, it is displayed together with information indicating at which time the diagram display is.

The thus-generated diagram at a user-designated time is output to the I/O means 1. At this time, GUI by which the user can designate a next display time is included therein for display. When a time to display the diagram is designated, the processing returns to step S41, and the subsequent processings may be repeatedly performed until the display end operation is performed (step S43).

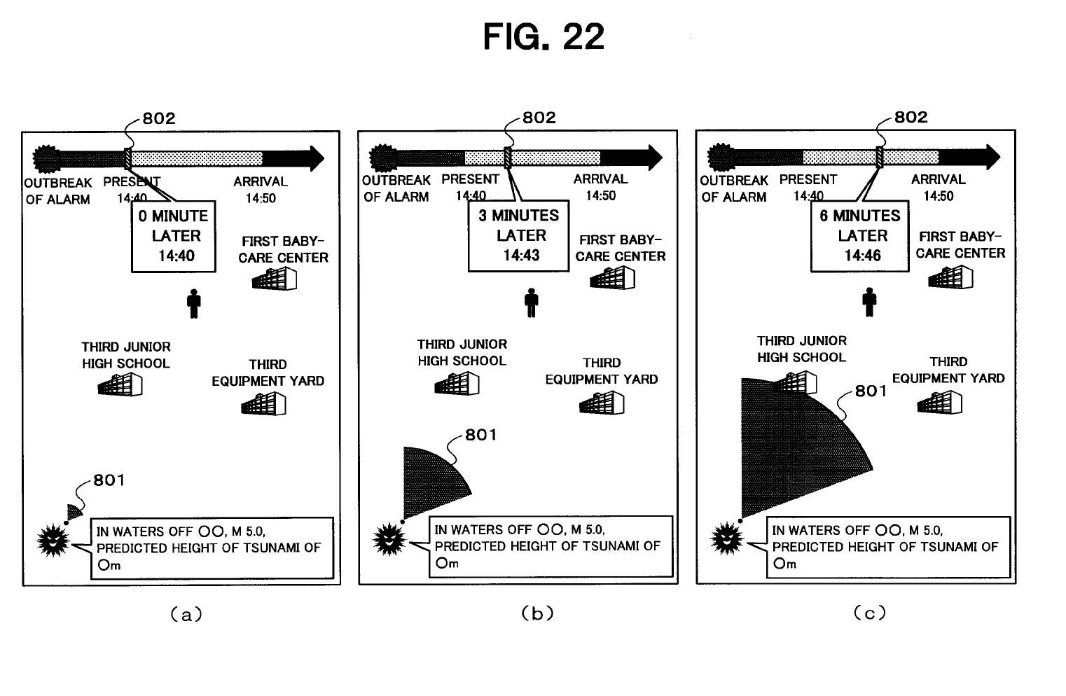

FIGS. 22(a) to 22(c) are the explanatory diagrams illustrating display images (exemplary output results) of a diagram according to the present exemplary embodiment. In FIGS. 22(a) to 22(c), the crisis arrival area 801 at a designated time is visualized by coloring the background in the relevant region in the diagram display according to the present exemplary embodiment. In each example, a slider bar 802 capable of designating a time to next display the diagram is used to perform the method for displaying information indicating at which time the diagram display is. For the time display, not only the information at a user-designated time but also the information on a time when the crisis breaks out, a current time and a time when the crisis will arrive at the point of the user is preferably presented together. FIG. 22(a) illustrates exemplary diagram display at a time when the information is first acquired, or a current time. FIG. 22(b) illustrates exemplary diagram display predicted three minutes later. FIG. 22(c) illustrates exemplary diagram display predicted further three minutes later, or six minutes after the current time.

The time sequential display/designation unit 8 may automatically designate any time between when the information is acquired and when the crisis arrives at the user based on a predetermined rule, not causing the user to select a time. Alternatively, the time may be automatically switched while indicating current display.

According to the present exemplary embodiment, the user can confirm the diagram and understand not only the current crisis status but also future status and impacts, thereby selecting safer and more appropriate actions.

The exemplary structure illustrate in FIG. 20 illustrates the example in which one device performs all the processings of managing information input for the user and relevant objects, acquiring the contents of a crisis, acquiring positional information of the user, crisis, and relevant objects to be displayed, calculating the directions from a position of the user, acquiring crisis impacts, designating a display time, and generating and outputting a diagram, but also in the present exemplary embodiment, all or part of the processings may be performed in other device. That is, various processings performed by the present crisis information delivery device may be realized by a server-client type crisis information delivery system. For example, the user/relevant object storage unit 2 may be provided in the server, and other processing units and information acquisition units from the storage unit may be provided in the user terminal. Further, for example, the processing units other than the I/O means 1, and the storage unit may be provided in the server, the user terminal may have only the function of transmitting operation information from the user to the server and the function of receiving and displaying information (such as diagram) output from the server, and other processings may be all performed in the server. The function distribution is not limited to the example.

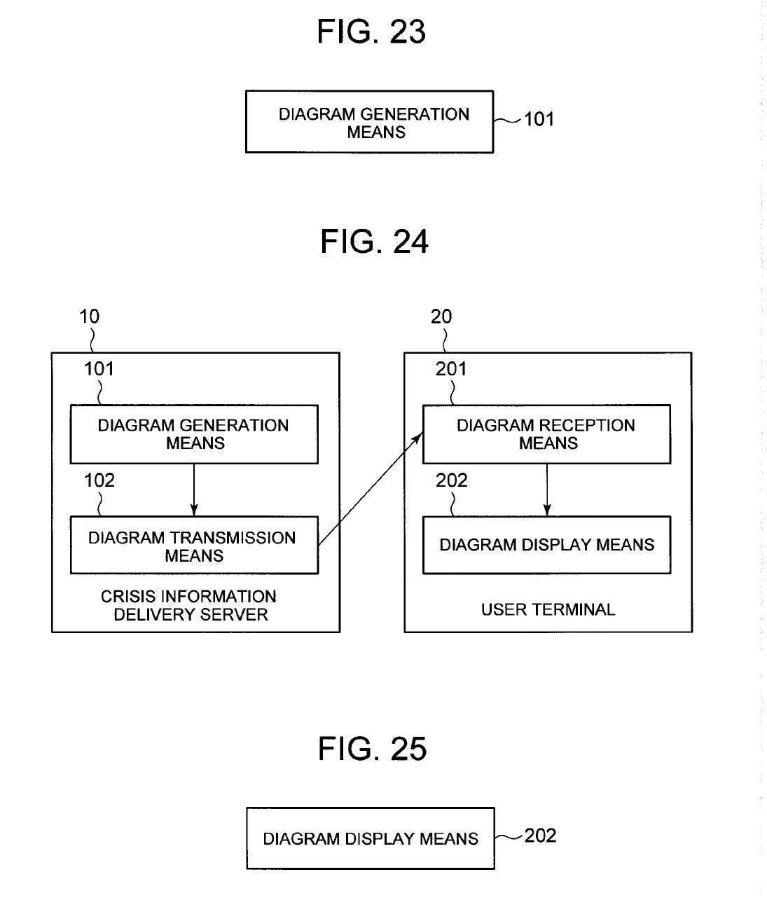

FIG. 23 is a block diagram illustrating a characteristic component in a crisis information delivery device according to the present invention. As illustrated in FIG. 23, the crisis information delivery device according to the present invention includes a diagram generation means 101 (the diagram generation unit 5, for example) for generating a diagram in which a crisis, a user, and relevant objects for the user are arranged in a predetermined drawing region while the directions from the user are kept at actual positions when the crisis breaks out, and crisis impacts as the degrees of hazard at the actual positions of the user and the relevant objects for the user are expressed in the distances from the crisis in the drawing region.

The diagram generation means 101 may generate a diagram in which visualizing expressing indicating a degree of crisis impact is made in a predetermined range with reference to the source of the crisis.

The diagram generation means 101 may generate a diagram including character information indicating the outline of a crisis, character information indicating the contents of crisis impacts at a position of the user, and character information indicating the contents of crisis impacts at the positions of the relevant objects for the user.

The crisis information delivery device according to the present invention may include a positional relationship calculation means (the positional relationship calculation unit 3, for example) for acquiring the source of a crisis, a position of a user, and positions of relevant objects for the user when the crisis breaks out, and calculating a direction from the position of the user toward the source of the crisis and the directions from the position of the user toward the positions of the relevant objects, a crisis impact acquisition means (the crisis/crisis impact acquisition unit 6, for example) for acquiring crisis impacts at the position of the user and the positions of the relevant objects, and an output means (the I/O means 1, for example) for outputting a diagram generated by the diagram generation means. In such a case, the diagram generation means 101 may generate a diagram based on the direction from the position of the user toward the source of the crisis and the directions from the position of the user toward the positions of the relevant objects acquired by the positional relationship calculation means, and the crisis impact at the position of the user and the crisis impacts at the positions of the relevant objects acquired by the crisis impact acquisition means.

The crisis information delivery device according to the present invention may include a relative object position acquisition means (an interface unit with the positional information acquisition unit 4 or the user/relevant object storage unit 2, for example) for acquiring at least the positions of evacuation spots as information on the relevant objects for the user.

The crisis information delivery device according to the present invention may include a map display generation means (the map display generation unit 7, for example) for generating map display in which a crisis, a user, and relevant objects for the user are arranged on a map according to their actual positions. In such a case, the output means may output the diagram generated by the diagram generation means and the map display generated by the map display generation means while switching them in response to a user operation.

The crisis information delivery device according to the present invention may include a display time designation means (the time sequential display/designation unit 8, for example) for designating a time to display a diagram. In such a case, the diagram generation means 101 may generate a diagram subjected to visualizing expression indicating the presence of a crisis impact at a time designated by the display time designation means.

FIG. 24 is a block diagram illustrating characteristic components in a crisis information delivery system according to the present invention. As illustrated in FIG. 24, the crisis information delivery system according to the present invention includes the user terminal 20, and the crisis information delivery server 10 connected to the user terminal 20 via a network, the crisis information delivery server 10 includes the diagram generation means 101 for generating a diagram in which a crisis, a user, and relevant objects for the user are arranged in a predetermined drawing region while the directions from the user are kept at actual positions when the crisis breaks out, and the crisis impacts as the degrees of hazard of the user and the relevant objects for the user at their actual positions are indicated in the distances from the crisis in the drawing region, and a diagram transmission means 102 for transmitting the diagram generated by the diagram generation means 101 to the user terminal 20, and the user terminal 20 includes a diagram reception means 201 for receiving the diagram from the diagram transmission means 102 and a diagram display means 202 for displaying the diagram received by the diagram reception means 201.

FIG. 25 is a block diagram illustrating a characteristic component in a user terminal according to the present invention. As illustrated in FIG. 25, the user terminal according to the present invention includes the diagram display means 202 for displaying a diagram in which a crisis, a user, and relevant objects for the user are arranged in a predetermined drawing region while the directions from the user are kept at their actual positions, and the crisis impacts as the degrees of hazard of the user and the relevant objects for the user at their actual positions are indicated in the distances from the crisis in the drawing region. The present structure includes displaying a diagram generated by the user terminal, and receiving and displaying a diagram generated by other device.

The present application claims the priority based on Japanese Patent Application No. 2012-154626 filed on Jul. 10, 2012, the disclosure of which is all incorporated herein by reference.

The present invention has been described above with reference to the exemplary embodiments, but the present invention is not limited to the above exemplary embodiments. The structure and details of the present invention may be variously changed within the scope understandable by those skilled in the art.

### INDUSTRIAL APPLICABILITY

The present invention is suitably applied to disaster prevention, disaster control, and victims' support by use of IT systems.

### REFERENCE SIGNS LIST

1 I/O means
2 User/relevant object storage unit
3 Positional relationship calculation unit
4 Positional information acquisition unit
5 Diagram generation unit
6 Crisis/crisis impact acquisition unit
61 Crisis outbreak reporting information reception unit
62 Crisis impact calculation unit
63 Crisis impact acquisition unit
7 Map display generation unit
8 Time sequential display/designation unit
100 Crisis information delivery system
10 Crisis information delivery server
20 User terminal
30 Network
101 Diagram generation means
102 Diagram transmission means
201 Diagram reception means
202 Diagram display means

What is claimed is:

1. A crisis information delivery device comprising:
a diagram generation unit for generating a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region.

2. The crisis information delivery device according to claim 1, comprising:
a positional relationship calculation unit for acquiring a position of the source of a crisis, a position of a user, and the positions of relevant objects for the user when the crisis breaks out, and calculating a direction from the position of the user toward the position of the source of the crisis, and the directions from the position of the user toward the positions of the relevant objects;
a crisis impact acquisition unit for acquiring crisis impacts at the position of the user and the positions of the relevant objects; and
an output unit for outputting a diagram generated by the diagram generation unit,
wherein the diagram generation unit generates a diagram based on the direction from the position of the user toward the position of the source of the crisis and the directions from the position of the user toward the positions of the relevant objects acquired by the positional relationship calculation unit, and the crisis impact at the position of the user and the crisis impacts at the positions of the relevant objects acquired by the crisis impact acquisition unit.

3. The crisis information delivery device according to claim 1, comprising:
a relevant object position acquisition unit for acquiring at least the position of an evacuation spot as information on a relevant object for the user.

4. The crisis information delivery device according to claim 1,
wherein the diagram generation unit generates a diagram subjected to visualizing expression indicating a degree of crisis impact within a predetermined range with reference to the source of the crisis.

5. The crisis information delivery device according to claim 1,
wherein the diagram generation unit generates a diagram including character information indicating the outline of the crisis, character information indicating the contents of a crisis impact at the position of the user, and character information indicating the contents of crisis impacts at the positions of the relevant objects for the user.

6. The crisis information delivery device according to claim 1, comprising:
a map display generation unit for generating map display in which a crisis, a user, and relevant objects for the user are arranged on a map according to their actual positions,
wherein the output unit outputs the diagram generated by the diagram generation unit and the map display generated by the map display generation unit while switching them in response to a user operation.

7. The crisis information delivery device according to claim 1, comprising:
a display time designation unit for designating a time to display a diagram,
wherein the diagram generation unit generates a diagram subjected to visualizing expression indicating the presence of a crisis impact at a time designated by the display time designation unit.

8. A crisis information delivery system comprising a user terminal, and a crisis information delivery server connected to the user terminal via a network,
wherein the crisis information delivery server includes:
a diagram generation unit for generating a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region; and
a diagram transmission unit for transmitting a diagram generated by the diagram generation unit to the user terminal, and
the user terminal includes:
a diagram reception unit for receiving the diagram from the diagram transmission unit; and
a diagram display unit for displaying the diagram received by the diagram reception unit.

9. A user terminal comprising:
a diagram display unit for displaying a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region.

10. A crisis information delivery method comprising the steps of:
generating a diagram in which a crisis, a user, and relevant objects for the user are arranged in a predetermined drawing region while the directions from the user at actual positions are kept when the crisis breaks out, and crisis impacts as the degrees of hazard at the actual positions of the user and the relevant objects for the user are indicated in the distances from the crisis in the drawing region; and
displaying the generated diagram on a user terminal.

11. The crisis information delivery method according to claim 10, comprising the steps of:
acquiring a position of the source of a crisis, a position of a user, and the positions of relevant objects for the user when the crisis breaks out, and calculating a direction from the position of the user toward the position of the source of the crisis, and the directions from the position of the user toward the positions of the relevant objects;
acquiring a crisis impact at the position of the user and crisis impacts at the positions of the relevant objects; and
generating a diagram based on the resultant direction from the position of the user toward the position of the source of the crisis and the resultant directions from the position of the user toward the positions of the relevant objects, and the crisis impact at the position of the user and the crisis impacts at the positions of the relevant objects.

12. The crisis information delivery method according to claim 10, comprising the steps of:
acquiring at least the position of a neighboring evacuation spot as information on a relevant object for the user; and
generating a diagram in which a crisis, a user, and relevant objects for the user including the neighboring evacuation spot are arranged while the directions from the user at actual positions are kept, and crisis impacts as the degrees of hazard at the actual positions of the user and the relevant objects for the user are indicated in the distances from the crisis in the drawing region.

13. The crisis information delivery method according to claim 10, comprising the step of:
generating a diagram subjected to visualizing expression indicating a degree of crisis impact within a predetermined range with reference to the source of the crisis.

14. The crisis information delivery method according to claim 10, comprising the step of:
generating a diagram including character information indicating the outline of the crisis, character information indicating the contents of a crisis impact at the position of the user, and character information indicating the contents of crisis impacts at the positions of the relevant objects for the user.

15. The crisis information delivery method according to claim 10, comprising the steps of:
generating map display in which a crisis, a user, and relevant objects for the user are arranged on a map according to their actual positions; and
displaying the diagram in which the crisis impacts are indicated in the distances from the crisis in the drawing region and the map display while switching them in response to a user operation.

16. The crisis information delivery method according to claim 10, comprising the steps of:
designating a time to display a diagram; and
generating a diagram subjected to visualizing expression indicating the presence of a crisis impact at a designated time.

17. A non-transitory computer readable recording medium in which a crisis information delivery program is recorded, the crisis information delivery program causing a computer to perform:
a processing of generating a diagram in which a crisis, a user, and relevant objects for the user are arranged in a predetermined drawing region while the directions from the user at actual positions are kept, and crisis impacts as the degrees of hazard at the actual positions of the user and the relevant objects for the user are indicated in the distances from the crisis in the drawing region; and
a processing of outputting the generated diagram.

18. A non-transitory computer readable recording medium in which a crisis information delivery program is recorded, the crisis information delivery program causing a computer to perform:
a processing of displaying a diagram in which a crisis, a user, and relevant objects for the user are arranged in a predetermined drawing region while the directions from the user at actual positions are kept, and crisis impacts as the degrees of hazard at the actual positions of the user and the relevant objects for the user are indicated in the distances from the crisis in the drawing region.
